(19) United States
(12) Patent Application Publication
(10) Pub. No.: US 2022/0110028 A1
(43) Pub. Date: Apr. 7, 2022

(54) Method for Cell Handover, Communication Device, and Satellite

(71) Applicant: GUANGDONG OPPO MOBILE TELECOMMUNICATIONS CORP., LTD., Dongguan, (CN)

(72) Inventor: Xin You, Dongguan (CN)

(21) Appl. No.: 17/555,074

(22) Filed: Dec. 17, 2021

Related U.S. Application Data
(63) Continuation of application No. PCT/CN2019/107001, filed on Sep. 20, 2019.

(51) Int. Cl. H04W 36/00; H04W 36/32

(52) U.S. Cl. CPC H04W 36/0058; H04W 88/06; H04W 36/00837; H04W 36/32

(57) ABSTRACT

A method for cell handover, a communication device, and a satellite are provided. The method includes the following. A measurement report of cell measurement is acquired. The measurement report is adjusted according to information representing a change in a communication distance between a terminal device and a network device, for cell handover.

### CROSS-REFERENCE TO RELATED APPLICATION(S)

This application is a continuation of International Application No. PCT/CN2019/107001, filed on Sep. 20, 2019, the entire disclosure of which is incorporated herein by reference.

### TECHNICAL FIELD

The present disclosure relates to the technical field of communication, and in particular, to a method for cell handover, a communication device, and a satellite.

### BACKGROUND

In a cellular network, a terminal device can perform cell measurement based on a measurement event configured by a network, and transmit a measurement report to a network device when a condition is met. A source base station can select a target base station for handover based on the measurement report. However, because a non-terrestrial network (NTN) system provides communication services to terrestrial users through satellite communication, a signal transmission delay between the terminal device and a satellite may increase greatly. In addition, the satellite keeps moving and this may lead to failure of the measurement report. Therefore, how to realize effective cell handover in the NTN system is a problem to be solved.

### SUMMARY

In a first aspect, a method for cell handover is provided. The method includes the following. A measurement report of cell measurement is acquired. The measurement report is adjusted according to information representing a change in a communication distance between a terminal device and a network device, for cell handover.

In a second aspect, a communication device is provided. The communication device includes a processor and a memory. The memory is configured to store computer programs. The processor is configured to invoke and execute the computer programs stored in the memory to perform the method in the first aspect or in any possible implementation of the first aspect.

In a third aspect, a satellite is provided. The satellite includes a processor, a transceiver, and a memory. The memory is configured to store computer programs. The processor is configured to invoke and execute the computer programs stored in the memory to cause the transceiver to receive a measurement report of cell measurement transmitted by a terminal device, determine a second satellite according to a satellite ephemeris, and further cause the transceiver to transmit the measurement report to the second satellite for cell handover.

### BRIEF DESCRIPTION OF DRAWINGS

FIG. 1 is a schematic diagram of a possible wireless communication system applied in implementations of the present disclosure.

FIG. 2 is an interaction flowchart of cell handover.

FIG. 3 is an interaction flowchart of conditional handover.

FIG. 4 is a schematic flowchart of a method for cell handover according to implementations of the present disclosure.

FIG. 5 is a schematic diagram of a possible implementation based on the method illustrated in FIG. 4.

FIG. 6 is a schematic diagram of a possible implementation based on the method illustrated in FIG. 4.

FIG. 7 is a schematic diagram illustrating locations of a satellite and a terminal device.

FIG. 8 is a schematic flowchart of a method for cell handover according to other implementations of the present disclosure.

FIG. 9 is a schematic diagram illustrating locations of satellites and a terminal device.

FIG. 10 is a schematic diagram illustrating satellite movement along an orbit.

FIG. 11 is a schematic diagram illustrating satellite movement along an orbit.

FIG. 12 is a schematic block diagram of a communication device according to implementations of the present disclosure.

FIG. 13 is a schematic structural diagram of a satellite according to implementations of the present disclosure.

FIG. 14 is a schematic structural diagram of a communication device according to implementations of the present disclosure.

FIG. 15 is a schematic structural diagram of an apparatus for cell handover according to implementations of the present disclosure.

### DETAILED DESCRIPTION

The following will describe technical solutions of implementations with reference to the accompanying drawings.

The technical solutions of implementations are applicable to various communication systems, for example, a global system of mobile communication (GSM), a code division multiple access (CDMA) system, a wideband code division multiple access (WCDMA) system, a long term evolution (LTE) system, an LTE frequency division duplex (FDD) system, an LTE time division duplex (TDD) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a universal mobile telecommunication system (UMTS), a wireless local area networks (WLAN), a wireless fidelity (WiFi), a 5G system, or other communication systems.

Generally, a conventional communication system generally supports a limited number of connections and therefore is easy to implement. However, with development of communication technology, a mobile communication system will not only support conventional communication but also support, for example, device to device (D2D) communication, machine to machine (M2M) communication, machine type communication (MTC), and vehicle to vehicle (V2V) communication. Implementations herein can also be applied to these communication systems.

In addition, a communication system of implementations may be applied to a carrier aggregation (CA) scenario, a dual connectivity (DC) scenario, or a standalone (SA) network deployment scenario, etc.

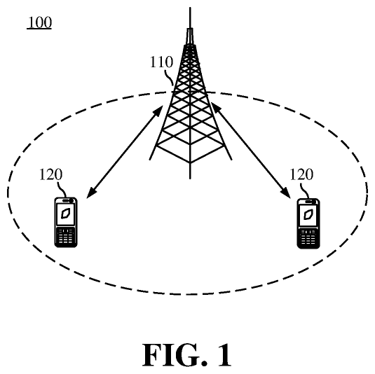

As illustrated in FIG. 1, a communication system 100 includes a network device 110. The network device 110 may be a device that can communicate with a terminal device 120. The network device 110 can provide a communication coverage for a specific geographical area and communicate with terminal devices in the coverage area.

In implementations of the present disclosure, the network device 110 may be, for example, a base transceiver station (BTS) in a GSM system or a CDMA system, a NodeB (NB) in a WCDMA system, an evolutional node B (ENB or eNodeB) in an LTE system, or a radio controller in a cloud radio access network (CRAN). Alternatively, the network device 110 may be a mobile switching center, a relay station, an access point, an in-vehicle device, a wearable device, a hub, a switch, a bridge, a router, a network device in a 5th generation (5G) network, or a network device in a future evolved public land mobile network (PLMN), etc. Alternatively, the network device 110 may also be a satellite in a non-terrestrial network (NTN) system.

The communication system 100 further includes at least one terminal device 120 located within the coverage of the network device 110. The terminal device 120 may be mobile or fixed. The terminal device 120 may be, for example, a user equipment (UE), an access terminal, a subscriber unit, a subscriber station, a mobile station, a remote station, a remote terminal, a mobile device, a user terminal, a terminal, a wireless communication device, a user agent, or a user device. The terminal device may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN in the future, etc., which is not limited herein. In addition, a terminal device 120 can perform device to device (D2D) communication with another terminal device 120.

The network device 110 can provide services for a cell. The terminal device 120 communicates with the network device 110 through a transmission resource corresponding to the cell. The cell may be a cell corresponding to the network device 110. The cell may correspond to a macro base station, or may correspond to a base station corresponding to a small cell. The small cell may include: a metro cell, a micro cell, a pico cell, a femto cell, and the like. These small cells are characterized by small coverage and low transmission power and are adapted to provide data transmission service with high-rate.

FIG. 1 exemplarily illustrates one network device and two terminal devices, which is not limited herein. The communication system 100 may include multiple network devices, and there can be other numbers of terminal devices in a coverage area of each of the network devices. In addition, the communication system 100 may further include other network entities such as a network controller and a mobility management entity.

Implementations of the present disclosure are applicable to an NTN system. In this case, the network device 110 in FIG. 1 can communicate with the terminal device via a satellite, or the network device 110 itself is a satellite.

An NTN system generally provides communication services to terrestrial users through satellite communication. Compared with terrestrial cellular network communication, the satellite communication has many unique advantages. First, the satellite communication is not constrained by areas of the users. For example, terrestrial communication is not able to cover sparsely populated areas as well as areas where communication devices cannot be set up, such as oceans, mountains, and deserts. In contrast, for the satellite communication, one satellite can cover a large area, and the satellite can orbit the earth, therefore, in theory, every corner on the earth can be covered for satellite communication. Second, the satellite communication has greater social value. Remote mountainous areas, poor and backward countries or regions can be covered for satellite communication at a low cost, so that people in these areas can enjoy advanced voice communication and mobile internet technologies, thereby narrowing a digital gap with developed areas and promoting the development of these areas. Third, a satellite has a long communication distance, and a communication cost thereof does not increase greatly with the increase of the communication distance. Finally, the satellite communication has high stability and is not constrained by natural disasters.

Communication satellites are classified into low-earth orbit (LEO) satellites, medium-earth orbit (MEO) satellites, geostationary earth orbit (GEO) satellites, high elliptical orbit (HEO) satellites, and the like according to different orbital altitudes. At present, the LEO satellite and the GEO satellite are mainly studied. For the LEO satellite, the orbital altitude thereof is in the range of 500 km to 1500 km, a corresponding orbital period is about 1.5 hours to 2 hours, and signal propagation delay of single-hop communication between users is generally less than 20 ms. A satellite has a maximum visibility time of 20 minutes, a short signal propagation distance, and a less link loss is small, and does not have high transmission power requirements for a user terminal. For the GEO satellite, the orbital altitude thereof is 35786 km, a rotation period around the earth thereof is 24 hours, and signal propagation delay of single-hop communication between users is generally 250 ms.

In order to ensure the coverage of the satellite and increase the system capacity of the entire satellite communication system, the satellite uses multi-beams to cover the ground. One satellite can provide dozens of or even hundreds of beams for ground coverage, and one beam can cover a ground area with a diameter of tens to hundreds of kilometers.

In the current NR system, a cell handover process can be defined as a process that due to the movement of a terminal device using a network service from one cell to another cell or due to wireless transmission service load regulation, activation operation maintenance, device failure, and the like, the NR system switches a communication link between the terminal device and a source cell to a new cell for ensuring communication continuity and quality of service. It should be understood that cell handover can be understood as network device handover, for example, a terminal device hands over from a source gNB to a target gNB.

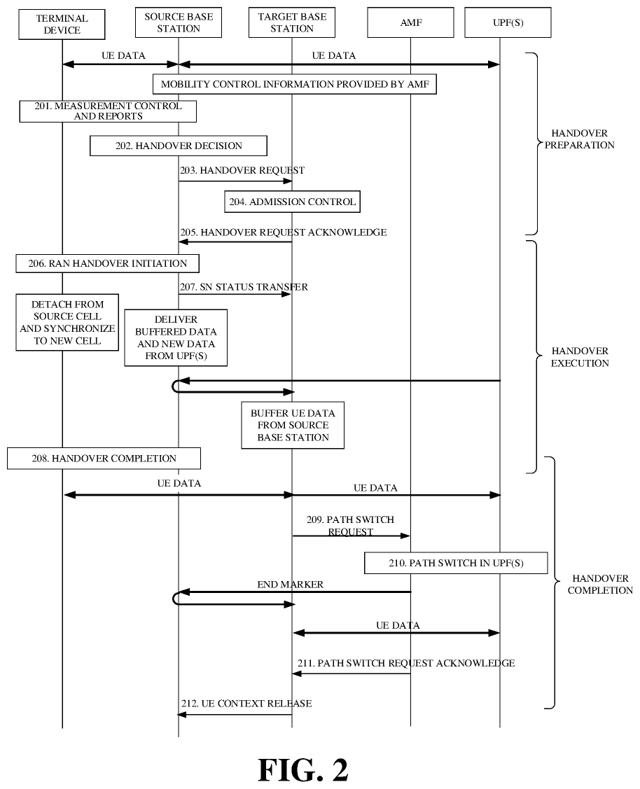

For ease of understanding, the following takes an Xn interface-based handover an as an example to describe the cell handover process. As illustrated in FIG. 2, the cell handover process mainly includes three processes, i.e., handover preparation, handover execution, and handover completion, which includes some or all of the following operations.

At 201, a terminal device performs measurement control and report.

At 202, a source base station makes a handover decision.

At 203, the source base station transmits a handover request message to a target base station.

The handover request message includes handover preparation related information.

At 204, the target base station performs admission control to increase a success rate of handover.

At 205, the target base station transmits a handover request acknowledge message to the source base station.

The handover request acknowledge message includes a handover command generated by the target base station. The source base station is not allowed to make any modification to the handover command generated by the target base station, but forward the handover command directly to the terminal device.

At 206, wireless access network (RAN) handover initiation is performed.

Upon reception of the handover command, the terminal device performs handover, that is, the terminal device disconnects from the source base station and connects to the target base station. For example, the terminal device initiates a random access process, transmits an RRC handover complete message to the target base station, and the like.

At 207, sequence number (SN) status transfer is performed.

The source base station transmits the SN status to the target base station.

At 208, the handover is completed.

At 209, the target base station transmits a path switch request message to an access and mobility management function (AMF) to notify the AMF that the terminal device has handed over to another cell.

At this time, air interface handover succeeds.

At 210, a path switch is performed in a user plane function (UPF) (path switch in UPF(s)).

At 211, the AMF transmits a path switch request acknowledge message to the target base station.

In 209 to 211, the target base station completes the path switch with the AMF and the UPF, to switch a user-plane data path from the source base station to the target base station.

After the data path is switched, data packets on a forward path and data packets on a new path may arrive at the target base station alternately. The target base station may first transfer all data packets on the forward path to the terminal device, and then transfer the packets received on the new path. In this way, a correct transmission sequence can be ensured. For assisting re-sequencing at the target base station, after the data path is switched, the AMF can transmit on an old path one or more packets with an “end marker”, where the packets does not include user data. After the packet with the “end marker” is transmitted, the AMF will not transmit on the old path any data packet. Upon reception of the packet with “end marker”, if forwarding is active for this bearer, the source base station will transmit this packet to the target base station. Upon detection of the packet with “end marker”, the target base station will discard the packet and initiate any required procedure to maintain sequential submission of a user.

At 212, the target base station transmits a UE context release message to the source base station.

Upon reception of a path switch acknowledge message, the target base station notifies the source base station that the handover is successful, and triggers the source base station to release resources. Upon reception of the UE context release message, the source base station can release radio bearers and control-plane resources related to UE context.

On one hand, there are some special scenarios, for example, where a terminal device moving at high speed or operating at high frequencies may experience frequent handover (HO). In these scenarios, conditional handover can be adopted. With aid of conditional handover, it is a problem that time for handover preparation is too long and the terminal device does not have enough time for handover can be avoided. A HO command can be configured for the terminal device in advance. On the other hand, in a high-speed rail scenario, the terminal device has a fixed moving trajectory. Therefore, the source base station can configure a target base station for the terminal device in advance, and the HO command may carry a condition for triggering the terminal device to perform handover. When the condition is met, the terminal device may initiate an access request to the target base station.

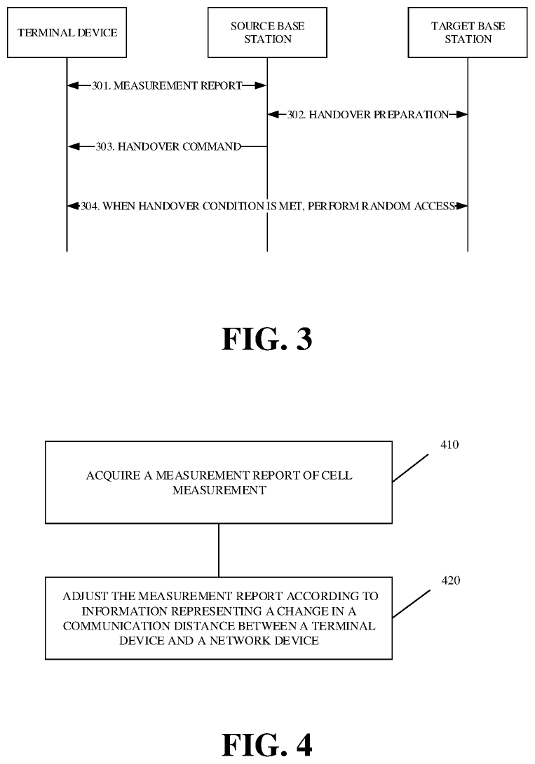

For example, as illustrated in FIG. 3, at 301, a terminal device transmits a measurement report to a source base station.

At 302, the source base station performs handover preparation with a target base station.

At 303, the source base station transmits a handover command to the terminal device.

At 304, when a handover condition is met, the terminal device performs random access to the target base station.

For operations related to measurement report, handover preparation, and handover command, reference may be made to the description corresponding to FIG. 2, which will not be repeated herein for the sake of simplicity.

Before cell handover, measurement configuration is required. The network device can configure for the terminal device a measurement object, a measurement condition, a handover condition, and the like, with which the terminal device can determine whether to perform cell handover. The measurement refers to mobility measurement of the terminal device in a connected state.

The measurement object is in units of frequency point. Each measurement object configured is a separate frequency point and has a separate measurement object identity. For evolved universal terrestrial radio access (E-UTRA) intra-frequency measurement and inter-frequency measurement, each measurement object is a single E-UTRA carrier frequency. For cells related to the carrier frequency, in E-UTRA, a cell offset list and a cell blacklist may be configured. During measurement evaluation and measurement report, no operation will be performed on cells in the cell blacklist.

Measurement report configurations can be classified into event-triggered measurement report configurations and periodical measurement report configurations. Each measurement report configuration has a separate identity. The event-triggered measurement report configuration includes an event type, a threshold, and time to trigger (TTT) required to satisfy a trigger condition. TTT is also known as trigger time. The periodical measurement report configuration includes a report period and a purpose of a periodical report.

At present, measurement events supported in the NR system include the following.

Event A1: serving becomes better than absolute threshold, i.e., serving>threshold.

Event A2: serving becomes worse than absolute threshold, i.e., serving<threshold.

Event A3: neighbour becomes amount of offset better than PCell/PSCell.

Event A4: neighbour becomes better than absolute threshold, i.e., neighbour>threshold.

Event A5: PCell/PSCell becomes worse than absolute threshold1 and neighbor/SCell becomes better than another absolute threshold2.

Event A6: neighbour becomes amount of offset better than SCell.

Event B1: neighbour becomes better than absolute threshold.

Event B2: PCell becomes worse than absolute threshold1 and neighbour becomes better than another absolute threshold2.

A measurement object is associated with a specific measurement report configuration via a separate measurement identity (ID). If a terminal device reaches a measurement start threshold, the terminal device will determine whether to perform measurement based on existence of the measurement identity.

Upon completion of the measurement, the terminal device performs measurement report evaluation if a trigger condition is met, and prepares a measurement report and transmits the measurement report to the network device if a report condition is met.

Measurement reports can be mainly classified into the following three types.

1. Event-Triggered

Transmission of a measurement report will be triggered only when a measurement event enter-threshold configured by the network is met and lasted for a period of time. This process will end after the measurement report is sent once. A measurement report configuration corresponding to this criterion is as follows.

The trigger type is “event-triggered”, where the event includes a measurement event among A1-A6 and B1-B2 and a threshold parameter thereof.

The report times is 1.

The UE will ignore the report gap regardless of the value of the report gap.

2. Periodical Report

After the network configures the measurement, the terminal device measures a corresponding frequency point according to the configuration and transmits a measurement report according to a specified report period and report gap.

The trigger period is “period”, including “reportCGI” and “reportStrongestCell”.

If the report purpose is “reportCGI”, the report times is 1. If the report purpose is “reportStrongestCell”, the report times can be greater than 1.

Upon configuration of a report with purpose “reportCGI”, the terminal device starts a T321 timer. In order for the network to obtain information required for creating a neighbor cell list as soon as possible, if the content required for a report is obtained before the expiration of the timer, the terminal device may stop T321 and initiate the report in advance.

3. Event-Triggered Periodical Report

Transmission of a measurement report will be triggered only when a measurement event enter-threshold configured by the network is met and lasted for a period of time. After the measurement report is triggered, a timer will be started multiple times between measurements, and a counter for measurement times will be started. This process ends when the report times meets the requirement. A measurement report configuration corresponding to this criterion is as follows.

The trigger type is “event-triggered”, where the event includes a measurement event among A1-A5 and a threshold parameter thereof.

The report times is greater than 1.

The report gap is valid, and the network sets a report-period timer according to a configured gap parameter.

In the NTN system, the satellite is far from the ground, and a signal transmission delay between the terminal device and the satellite increases greatly. When received at the source base station, the measurement report may become invalid. In addition, due to the continuous movement of the satellite, the measurement report regarding the satellite reported by the terminal device may also become invalid. Therefore, effective cell handover cannot be ensured.

To this end, the present disclosure provides a cell handover method. Through the method, a more accurate measurement report can be acquired and cell handover in the NTN system can be effectively realized.

FIG. 4 is a schematic flowchart of a method for cell handover according to implementations of the present disclosure. The method illustrated in FIG. 4 can be performed by a terminal device or a network device. The network device is, for example, the network device 110 in FIG. 1, and the terminal device is, for example, the terminal device 120 in FIG. 1. As illustrated in FIG. 4, the method includes some or all of the following operations.

At 410, a measurement report of cell measurement is acquired.

At 420, the measurement report is adjusted according to information representing a change in a communication distance between a terminal device and a network device, for cell handover.

In this implementation, the terminal device or the network device can adjust the measurement report acquired through cell measurement, according to the information representing the change in the communication distance between the terminal device and the network device, such as amount of change in distance or time etc., so that the measurement report is applicable to the terminal device and the network device at current locations. In this way, the network device can perform cell handover based on the adjusted measurement report, thereby effectively realizing cell handover in the NTN system.

The network device may be a satellite or a ground station, such as a base station.

If the network device is a satellite, the communication distance between the terminal device and the network device is a distance between the terminal device and the satellite. If the network device is a ground station, the communication distance between the terminal device and the network device is a sum of a distance between the terminal device and a satellite and a distance between the satellite and the ground station.

For example, for transparent GEO/LEO, a satellite can realize functions of a base station, so the network device may be a satellite. In other words, a satellite may function as the network device to communicate with the terminal device. In this case, the distance between the terminal device and the network device is the distance between the terminal device and the satellite. For another example, for regenerative GEO/LEO, uplink data from the terminal device is transmitted to the ground station via a satellite, and downlink data from the ground station is transmitted to the terminal device via the satellite, so the network device is the ground station. In this case, the distance between the terminal device and the network device includes the distance between the terminal device and the satellite and the distance between the satellite and the ground station. Upon reception of the measurement report reported by the terminal device, the satellite will forward the measurement report to the ground station.

An LEO satellite is relatively mobile, and the distance between the satellite and the ground station varies. A GEO satellite is relatively static, and the distance between the satellite and the ground station is fixed.

The method illustrated in FIG. 4 can be performed by a terminal device. FIG. 5 is an interaction flowchart illustrating a method for cell handover performed by a terminal device according to implementations of the present disclosure. The operation at 410 may be replaced by operation at 411.

At 411, the terminal device acquires a measurement report by performing cell measurement.

At 420, the terminal device adjusts the measurement report according to information representing a change in a communication distance between the terminal device and a network device.

At 430, the terminal device transmits the adjusted measurement report to the network device.

At 440, the network device receives the adjusted measurement report transmitted by the terminal device.

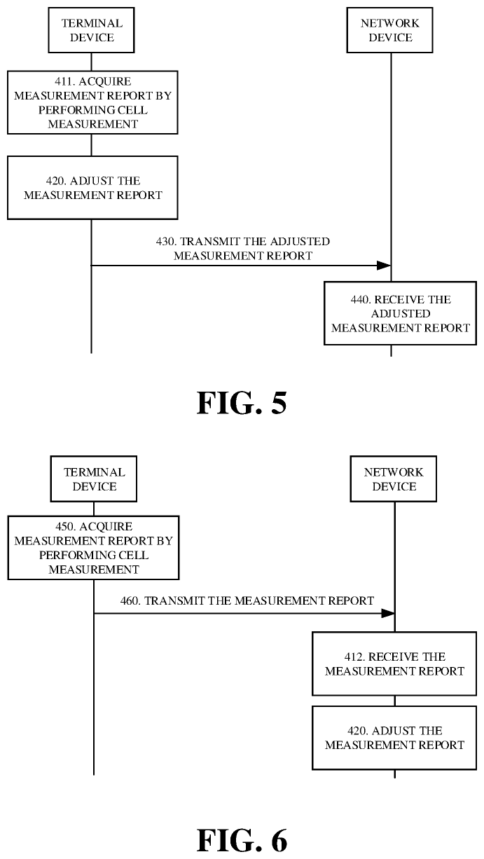

The method illustrated in FIG. 4 can also be performed by a network device. FIG. 6 is an interaction flowchart illustrating a method for cell handover performed by a network device according to implementations of the present disclosure. The operation at 410 may be replaced by operation at 412.

At 450, the terminal device acquires a measurement report by performing cell measurement.

At 460, the terminal device transmits the measurement report to a network device.

At 412, the network device receives the measurement report transmitted by the terminal device.

At 420, the network device adjusts the measurement report according to information representing a change in a communication distance between the terminal device and the network device.

The information representing the change in the communication distance between the terminal device and the network device may include, for example, amount of change in distance or time. At 420, the terminal device or the network device may adjust the measurement report based on the amount of change in distance or time.

In some implementations, at 420, the terminal device or the network device adjusts the measurement report according to an amount of change in the communication distance between the terminal device and the network device.

The communication distance may be, for example, a difference between the communication distance at a first moment and the communication distance at a second moment.

At the first moment, the measurement report may be generated at the terminal device, and at the second moment, the measurement report may be received at the network device.

The terminal device or the network device may determine the amount of change in the communication distance according to at least one of: round-trip time (RTT) between the terminal device and the network device, a moving distance of a satellite, and a moving distance of the terminal device.

The moving distance of the satellite can be determined based on a satellite ephemeris. The satellite ephemeris includes a moving trajectory of the satellite and other information. The moving distance of the terminal device may be determined based on a moving speed and a moving trajectory of the terminal device, for example, a trajectory and a speed of a high-speed rail in a high-speed rail scenario.

The change in the communication distance between the terminal device and the network device may be caused by the movement of the satellite or the terminal device. When the network device is a satellite, the communication distance is a distance between the terminal device and the satellite. When the network device is a ground station, the communication distance is a sum of a distance between the terminal device and a satellite and a distance between the satellite and the ground station.

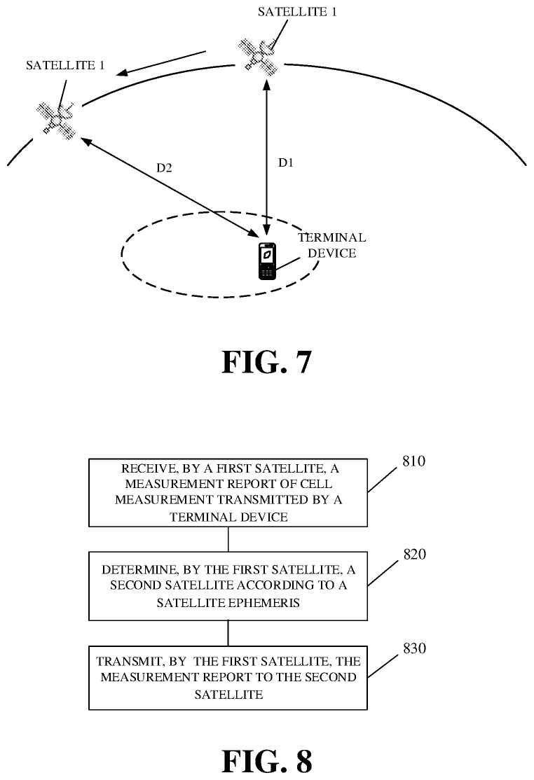

For example, as illustrated in FIG. 7, assuming that the network device is satellite 1, satellite 1 is constantly mobile, and the terminal device is relatively static. The terminal device performs cell measurement and generates a measurement report. When the measurement report is generated at the terminal device, the distance between the terminal device and satellite 1 is D1. However, satellite 1 is constantly mobile and far away from the ground. Therefore, when the measurement report is received at satellite 1, the distance between the terminal device and satellite 1 may become D2. Therefore, the measurement report generated by the terminal device can be adjusted according to a difference between D2 and D1. The terminal device may adjust the measurement report based on a difference between D1 and D2, that is, D2−D1 and transmit the adjusted measurement report to satellite 1. Alternatively, the terminal device may transmit to satellite 1 the measurement report acquired through measurement. Satellite 1 may adjust the measurement report based on a difference between D1 and D2, that is D2−D1, and then based on the adjusted measurement report, perform cell handover, such as the operations performed by the source base station as illustrated in FIG. 2 and FIG. 3, to select a suitable target cell for the terminal device.

When the network device is a ground station, D1 and D2 each include not only the distance between the terminal device and satellite 1, but also the distance between satellite 1 and the ground station.

If D2−D1 is a positive value, that is, the distance between satellite 1 and the terminal device increases, a measured value reflecting a signal quality of the cell in the measurement report may be reduced, examples of the measured value include a measured value of reference signal receiving power (RSRP), reference signal receiving quality (RSRQ), and the like. On the other hand, if D2−D1 is a negative value, that is, the distance between satellite 1 and the terminal device decreases, the measured value in the measurement report may be increased.

In other implementations, at 420, the terminal device or the network device adjusts the measurement report according to a time difference between a first moment and a second moment.

At the first moment, the measurement report is generated at the terminal device, and at the second moment, the measurement report is received at the network device.

The measurement report acquired by the terminal device through cell measurement has a certain timeliness. If the time difference T2−T1 between the first moment T1 and the second moment T2 is less than a valid duration of the measurement report, that is, the measurement report is still valid when received at the network device, there is no need to adjust the measurement report. If the time difference T2−T1 between the first moment T1 and the second moment T2 is greater than the valid duration of the measurement report, that is, the measurement report has become invalid when received at the network device, the measurement report needs to be adjusted.

For example, if the time difference between the first moment T1 and the second moment T2 is greater than the valid duration, the measured value reflecting the signal quality of the cell in the measurement report, such as the measured value of RSRP, RSRQ, and the like may be adjusted. The greater the time difference, the greater the amount of adjustment.

In implementations of the present disclosure, at 420, the terminal device or the network device may determine an adjustment parameter according to the information representing the change in the communication distance, and adjust the measurement report by using the adjustment parameter.

The adjustment parameter includes, for example, at least one of: an adjustment factor, an adjustment step size, an adjustment period, and the like.

The adjustment period may be a time period or a distance period. For example, the measurement report is adjusted once every time period or distance period.

If the measurement report is adjusted based on the amount of change in distance, when D2−D1=0, a corresponding adjustment amount is 0, that is, there is no need to adjust the measured value in the measurement report. When D2−D≠0, the terminal device adjusts the measured value according to the adjustment parameter.

For example, assuming that the measured value acquired by the terminal device through cell measurement is I₀ and the adjustment factor is M, then the measured value I₁ obtained through adjustment is I₁=I₀×M.

When D2>D1, the satellite moves away from the terminal device, the communication link becomes longer, and the measured value may be reduced, therefore, 0<M<1. When D2<D1, the satellite moves close to the terminal device, the communication link becomes shorter, and the measured value may be increased, therefore, M>1. Further, each time the distance between the terminal device and the satellite increases or decreases by a distance period D0, the value of M is adjusted once accordingly. The amount for each adjustment may be the same or different.

For another example, assuming that the measured value acquired by the terminal device through cell measurement is I₀ and the adjustment step size is N, then the adjusted measured value h obtained through adjustment is I₁=I₀+N.

When D2>D1, the satellite moves away from the terminal device, the communication link becomes longer, and the measured value may be reduced, therefore, N<0. When D2<D1, the satellite moves close to the terminal device, the communication link becomes shorter, and the measured value may be increased, therefore, N>0. Further, each time the distance between the terminal device and the satellite increases or decreases by a distance period D0, the value of N is adjusted once accordingly. The amount for each adjustment may be the same or different.

Similarly, if the measurement report is adjusted based on the time difference, when T2−T1≤T0, a corresponding adjustment amount is 0, that is, there is no need to adjust the measured value in the measurement report, where T0 is the valid duration of the measurement report. When T2−T1>T0, the terminal device adjusts the measured value according to the adjustment parameter.

The valid duration of the measurement report can be determined by the terminal device based on a moving trajectory and a moving speed of the terminal device, a satellite ephemeris, and the like, or by the network device based on the moving speed and the moving trajectory of the terminal device, the satellite ephemeris, and the like, or can be pre-agreed.

For example, assuming that the measured value acquired by the terminal device through cell measurement is I₀ and the adjustment factor is M, then the measured value I₁ obtained through adjustment is I₁=I₀×M. Each time the value of T2−T1 increases by a time period T0, the value of M is adjusted once accordingly.

For another example, assuming that the measured value acquired by the terminal device through cell measurement is I₀ and the adjustment step size is N, then the measured value I₁ obtained through adjustment is I₁=I₀+N. Each time the value of T2−T1 increases by a time period T0, the value of N is adjusted once accordingly. The amount for each adjustment may be the same or different. In addition, the value of N is adjusted to a smaller value based on a determination that the distance between the satellite and the terminal device gradually increases. The value of N is adjusted to a larger value based on a determination that the distance between the satellite and the terminal device gradually decreases.

In addition, in implementations of the present disclosure, the measurement report may also carry the adjustment amount of the measured value in the measurement report, the first moment when the measurement report is generated, and location information of the terminal device.

In addition, if the terminal device receives a NACK for the measurement report from the network device after transmitting the measurement report to the network device, the terminal device may further adjust the measurement report based on the foregoing method.

FIG. 8 is a schematic flowchart of a method for cell handover according to other implementations of the present disclosure. As illustrated in FIG. 8, the method includes some or all of the following operations.

At 810, a first satellite receives a measurement report of cell measurement transmitted by a terminal device.

At 820, the first satellite determines a second satellite according to a satellite ephemeris.

At 830, the first satellite transmits the measurement report to the second satellite for cell handover.

In this implementation, when the measurement report is no longer applicable due to the increase of the distance between the first satellite and the terminal device, the first satellite forwards the measurement report to the second satellite for the second satellite to perform cell handover, thereby effectively realizing cell handover in the NTN system.

The terminal device may perform cell measurement based on a measurement configuration of the first satellite, and the measurement configuration includes, for example, a measurement object, a measurement threshold, a measurement event, and the like. When a measurement result satisfies or reaches the measurement threshold, the terminal device generates a measurement report and reports the measurement report to the first satellite.

However, when the first satellite receives the measurement report, the communication distance between the first satellite and the terminal device may have been changed. When the communication distance changes greatly, link conditions may change significantly, the measurement report may be no longer applicable to the first satellite, or the first satellite cannot even provide coverage for a cell where the terminal device is located. Therefore, it is impossible for the first satellite to select a suitable target cell for the terminal device based on the measurement report. In this case, the first satellite can transmit the measurement report to the second satellite for the second satellite to perform cell handover. In terms of selection of the second satellite, a satellite in a suitable location can be selected as the second satellite according to the satellite ephemeris, so that the measurement report is applicable to the second satellite. The first satellite may transmit the measurement report to the second satellite over an Xn interface.

On the one hand, the second satellite performs cell handover with the measurement report, thereby increasing a success rate of cell handover. On the other hand, unnecessary signaling interaction between the terminal device and the second satellite may be omitted, thereby saving air interface resources.

In addition to the measurement result of cell measurement, the measurement report may also include at least one of: a moving trajectory of the terminal device, a moving speed of the terminal device, a valid duration of the measurement report, and the like.

In this case, at 820, the first satellite determines the second satellite according to the satellite ephemeris as follows. The first satellite determines the second satellite according to the satellite ephemeris and the measurement report.

In this implementation, a distance between the first satellite and the terminal device is greater than a distance between the second satellite and the terminal device at a moment when the measurement report is received at the second satellite. Preferably, the second satellite is at or near a location, where the first satellite was at when the measurement report was generated at the terminal device.

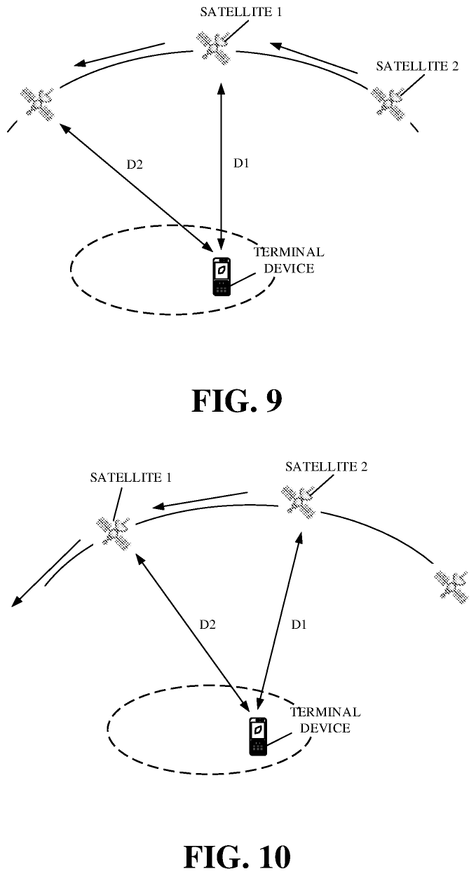

For example, as illustrated in FIGS. 9 to 11, the terminal device performs cell measurement based on a measurement configuration of satellite 1 and performs measurement report. When satellite 1 receives the measurement report transmitted by the terminal device, a link state changes due to the movement of satellite 1. Therefore, the measurement report may be no longer accurate for or applicable to satellite 1. In this case, satellite 1 can transmit the measurement report to satellite 2, and satellite 2 will then perform cell handover to select a suitable target cell for the terminal device.

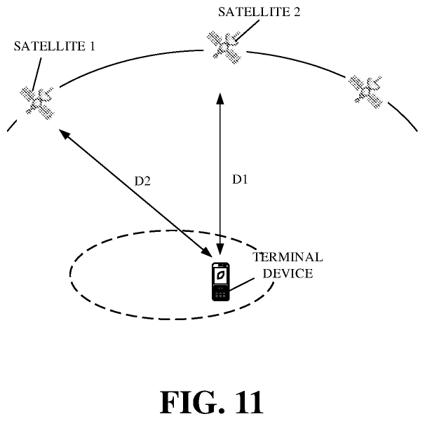

FIG. 9 illustrates the locations of satellite 1 and satellite 2 when the measurement report is generated at the terminal device. FIG. 10 illustrates the locations of satellite 1 and satellite 2 when the measurement report is received at satellite 1. Satellite 1 and satellite 2 keep moving along the orbit. When satellite 1 receives the measurement report, the distance between satellite 1 and the terminal device changes, and the measurement report is no longer accurate for satellite 1. Therefore, satellite 1 forwards the measurement report to satellite 2. When satellite 2 receives the measurement report, satellite 1 and satellite 2 move to the locations illustrated in FIG. 11. In this case, the second satellite performs cell handover according to the measurement report. The terminal device performs cell measurement and generates the measurement report based on the measurement configuration of satellite 1, so the measurement report is applicable to satellite 1 at the location illustrated in FIG. 9. Therefore, when satellite 2 moves to the location of satellite 1 illustrated in FIG. 9, the measurement report is applicable to satellite 2 at that location. Satellite 1 transmits the measurement report to satellite 2, and satellite 2 selects the target cell for the terminal device, thereby effectively improving the performance of cell handover.

In this implementation, optionally, the method further includes the following. The first satellite adjusts the measurement report according to information representing a change in a communication distance between the terminal device and the first satellite. In this case, at 430, the first satellite transmits the adjusted measurement report to the second satellite.

Optionally, the first satellite adjusts the measurement report according to the information representing the change in the communication distance between the terminal device and the satellite as follows. The first satellite adjusts the measurement report according to an amount of change in the communication distance.

Optionally, the amount of change in the communication distance is a difference between the communication distance between the terminal device and the first satellite at a first moment and the communication distance between the terminal device and the second satellite at a second moment.

At the first moment, the measurement report is generated at the terminal device, and at the second moment, the measurement report is received at the first satellite.

Optionally, the method further includes the following. The first satellite determines the amount of change in the communication distance according to at least one of: RTT between the terminal device and the first satellite, a moving distance of the first satellite, and a moving distance of the second satellite, and a moving distance of the terminal device.

Optionally, the first satellite adjusts the measurement report according to the information representing the change in the communication distance between the terminal device and the first satellite as follows. The first satellite adjusts the measurement report according to a time difference between a first moment and a second moment.

At the first moment, the measurement report is generated at the terminal device, and at the second moment, the measurement report is received at the first satellite.

Optionally, the first satellite adjusts the measurement report according to the information representing the change in the communication distance between the terminal device and the first satellite as follows. An adjustment parameter is determined according to the information representing the change in the communication distance. The measurement report is adjusted with the adjustment parameter.

The adjustment parameter includes, for example, at least one of: an adjustment factor, an adjustment step size, and an adjustment period.

It should be understood that, the first satellite can adjust the measurement report according to the information representing the change in the communication distance between the terminal device and the first satellite, which may refer to the description of adjusting the measurement report in relation to FIG. 4 and will not be repeated herein for the sake of simplicity.

In this implementation, the measurement report transmitted by the terminal device to the first satellite may be a measurement report adjusted by the terminal device based on the method illustrated in FIG. 4. The first satellite directly forwards the measurement report adjusted by the terminal device to the second satellite.

Alternatively, the terminal device transmits the measurement report to the first satellite, the first satellite directly forwards the measurement report to the second satellite, and the second satellite adjusts the measurement report based on the foregoing method.

In other words, the measurement report may be adjusted by the terminal device, the first satellite, or the second satellite. The measurement report may be adjusted based on the difference between the distance between the first satellite and the terminal device when the measurement report is generated and the distance between the second satellite and the terminal device when the measurement report is received at the second satellite. If the location of the second satellite when the measurement report is received at the second satellite is the same as the location of the first satellite when the measurement report is generated at the terminal device, the measurement report may not be adjusted.

In addition, the measurement report may also carry the adjustment amount of the measured value in the measurement report by the terminal device, the first moment when the measurement report is generated, and location information of the terminal device.

In implementations of the present disclosure, the terminal device can perform cell handover based on a measurement configuration, that is, perform measurement report when a handover condition is met. Alternatively, the terminal device can also automatically trigger cell handover. For example, the terminal device automatically performs cell measurement and measurement report when moving to an edge of a current serving cell.

It should be noted that respective implementations described in the present disclosure and/or the technical features in the respective implementations may be combined with each other arbitrarily without conflicting, and the technical solutions obtained via the combination should also fall within the scope of the present disclosure.

In various implementations of the present disclosure, the sequence number of the above-mentioned processes does not mean an execution order, and the execution order of each process should be determined by the function and internal logic thereof, which does not limit the implementation of the present application.

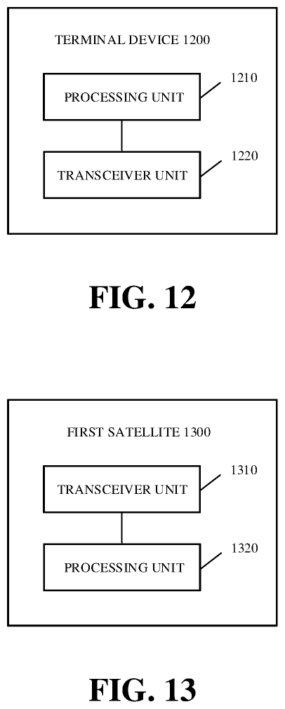

The method for cell handover according to implementations of the present disclosure is described in detail herein. Devices according to implementations of the present disclosure will be described below in conjunction with FIGS. 12 to 15. The technical features described in the method implementations are applicable to the following device implementations.

FIG. 12 is a schematic block diagram of a communication device 1200 according to implementations of the present disclosure. As illustrated in FIG. 12, the communication device 1200 includes a processing unit 1210 and a transceiver unit 1220.

The processing unit 1210 is configured to acquire a measurement report of cell measurement, and adjust the measurement report according to information representing a change in a communication distance between a terminal device and a network device, for cell handover.

Therefore, the measurement report acquired through cell measurement is adjusted according to the information representing the change in the communication distance between the terminal device and the network device, so that the measurement report is applicable to the terminal device and the network device at current locations. In this way, the network device can perform cell handover based on the adjusted measurement report, thereby effectively realizing cell handover in the NTN system.

Optionally, the processing unit 1210 is configured to adjust the measurement report according to an amount of change in the communication distance.

Optionally, the amount of change in the communication distance is a difference between the communication distance at a first moment and the communication distance at a second moment, where at the first moment, the measurement report is generated at the terminal device, and at the second moment, the measurement report is received at the network device.

Optionally, the processing unit 1210 is further configured to determine the amount of change in the communication distance according to at least one of: RTT between the terminal device and the network device, a moving distance of a satellite, and a moving distance of the terminal device.

Optionally, the processing unit 1210 is configured to adjust the measurement report according to a time difference between a first moment and a second moment, where at the first moment, the measurement report is generated at the terminal device, and at the second moment, the measurement report is received at the network device.

Optionally, the processing unit 1210 is configured to determine an adjustment parameter according to the information representing the change in the communication distance, and adjust the measurement report with the adjustment parameter.

Optionally, the adjustment parameter includes at least one of: an adjustment factor, an adjustment step size, and an adjustment period.

Optionally, the communication device is the terminal device. The processing unit 1210 is configured to acquire the measurement report by performing cell measurement. The transceiver unit 1220 is configured to transmit the adjusted measurement report to the network device.

Optionally, the communication device is the network device. The processing unit 1210 is configured to control the transceiver unit 1220 to receive the measurement report transmitted by the terminal device.

Optionally, the network device is a satellite, and the communication distance is a distance between the terminal device and the satellite, or the network device is a ground station, and the communication distance is a sum of a distance between the terminal device and a satellite and a distance between the satellite and the ground station.

It should be understood that the communication device 1200 may perform corresponding operations performed by the terminal device or the network device in the method illustrated in FIG. 4, which will not be repeated herein for the sake of simplicity.

FIG. 13 is a schematic block diagram of a satellite 1300 according to implementations of the present disclosure. As illustrated in FIG. 13, satellite 1300 is a first satellite. The first satellite includes a transceiver unit 1310 and a processing unit 1320.

The transceiver unit 1310 is configured to receive a measurement report of cell measurement transmitted by a terminal device.

The processing unit 1320 is configured to determine a second satellite according to a satellite ephemeris.

The transceiver unit 1310 is further configured to transmit the measurement report to the second satellite for cell handover.

Therefore, when the measurement report is no longer applicable due to the increase of the distance between the first satellite and the terminal device, the first satellite forwards the measurement report to the second satellite for the second satellite to perform cell handover, thereby effectively realizing cell handover in the NTN system.

Optionally, the measurement report includes a measurement result of cell measurement and at least one of: a moving trajectory of the terminal device, a moving speed of the terminal device, and a valid duration of the measurement report. The processing unit 1320 is configured to determine the second satellite according to the satellite ephemeris and the measurement report.

Optionally, a distance between the first satellite and the terminal device is greater than a distance between the second satellite and the terminal device at a second moment when the measurement report is received at the first satellite.

Optionally, the processing unit 1320 is further configured to adjust the measurement report according to information representing a change in a communication distance between the terminal device and a satellite. The transceiver unit 1310 configured to transmit the measurement report to the second satellite is configured to transmit the adjusted measurement report to the second satellite.

Optionally, the processing unit 1320 is configured to adjust the measurement report according to an amount of change in the communication distance.

Optionally, the amount of change in the communication distance is a difference between the communication distance between the terminal device and the first satellite at a first moment and the communication distance between the terminal device and the second satellite at a second moment, where at the first moment, the measurement report is generated at the terminal device, and at the second moment, the measurement report is received at the first satellite.

Optionally, the processing unit 1320 is further configured to determine the amount of change in the communication distance according to at least one of: RTT between the terminal device and the first satellite, a moving distance of the first satellite, and a moving distance of the second satellite, and a moving distance of the terminal device.

Optionally, the processing unit 1320 is configured to adjust the measurement report according to a time difference between a first moment and a second moment, wherein at the first moment, the measurement report is generated at the terminal device, and at the second moment, the measurement report is received at the first satellite.

Optionally, the processing unit 1320 is configured to determine an adjustment parameter according to the information representing the change in the communication distance, and adjust the measurement report with the adjustment parameter.

Optionally, the adjustment parameter comprises at least one of: an adjustment factor, an adjustment step size, and an adjustment period.

It should be understood that the satellite 1300 may perform corresponding operations performed by the first satellite in the method illustrated in FIG. 8, which will not be repeated herein for the sake of simplicity.

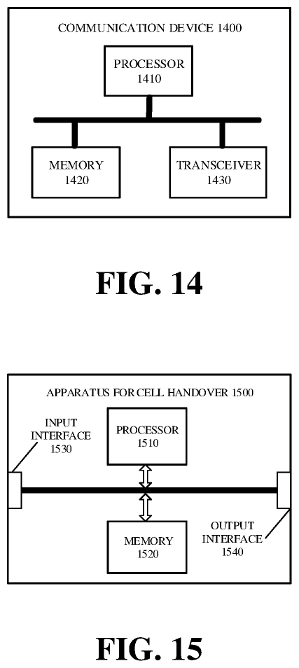

FIG. 14 is a schematic structural diagram of a communication device 1400 according to implementations of the present disclosure. As illustrated in FIG. 14, the communication device 1400 includes a processor 1410. The processor 1410 can invoke and execute computer programs stored in a memory to perform the method provided in implementations of the present disclosure.

Optionally, as illustrated in FIG. 14, the communication device 1400 can further include the memory 1420. Specifically, the processor 1410 can invoke and execute the computer programs stored in the memory 1420 to perform the method provided in implementations of the present disclosure.

The memory 1420 may be a separate device independent of the processor 1410, or may be integrated into the processor 1410.

Optionally, as illustrated in FIG. 14, the communication device 1400 can further include a transceiver 1430. The processor 1410 can control the transceiver 1430 to communicate with other devices, for example, to transmit information or data to other devices, or to receive information or data from other devices.

The transceiver 1430 may include a transmitter and a receiver. The transceiver 1430 may further include an antenna, where one or more antennas can be provided.

Optionally, the communication device 1400 may be the terminal device of implementations of the present disclosure, and the communication device 1400 can implement the operations performed by the terminal device described in the foregoing method implementations of the present disclosure, which will not be repeated herein for the sake of simplicity.

Optionally, the communication device 1400 may be the network device of implementations of the present disclosure, and the communication device 1400 can implement the operations performed by the network device described in the foregoing method implementations of the present disclosure, which will not be repeated herein for the sake of simplicity. The network device may be a satellite or a ground station.

FIG. 15 is a schematic structural diagram of an apparatus for cell handover according to implementations of the present disclosure. As illustrated in FIG. 15, the apparatus 1500 includes a processor 1510. The processor 1510 is configured to invoke and execute computer programs stored in a memory to perform the method provided in implementations of the present disclosure.

Optionally, as illustrated in FIG. 15, the apparatus 1500 further includes a memory 1520. The processor 1510 can invoke and execute the computer programs stored in the memory 1520 to perform the method provided in implementations of the present disclosure.

The memory 1520 may be a separate device independent of the processor 1510, or may be integrated into the processor 1510.

Optionally, the apparatus 1500 may further include an input interface 1530. The processor 1510 can control the input interface 1530 to communicate with other devices or chips, for example, specifically, to acquire information or data sent by other devices or chips.

Optionally, the apparatus 1500 may further include an output interface 1540. The processor 1510 can control the output interface 1540 to communicate with other devices or chips, for example, specifically, to output information or data to other devices or chips.

Optionally, the apparatus 1500 is applicable to the network device of implementations of the present disclosure. The communication apparatus can implement the operations performed by the network device described in the foregoing method implementations, which will not be repeated herein for the sake of simplicity. The network device may be a satellite or a ground station.

Optionally, the apparatus 1500 is applicable to the terminal device of implementations of the present disclosure. The communication apparatus can implement the operations performed by the terminal device described in the foregoing method implementations, which will not be repeated herein for the sake of simplicity.

The apparatus 1500 may be a chip. The chip may be a system-on-chip (SOC).

The processor referred to herein may be an integrated circuit chip with signal processing capabilities. During implementation, each step of the foregoing method may be completed by an integrated logic circuit in the form of hardware or an instruction in the form of software in the processor. The processor may be a general-purpose processor, a digital signal processor (DSP), an application specific integrated circuit (ASIC), a field programmable gate array (FPGA), or other programmable logic devices, discrete gates or transistor logic devices, or discrete hardware components, which can implement or perform the methods, steps, and logic blocks disclosed in implementations. The general purpose processor may be a microprocessor, or the processor may be any conventional processor or the like. The steps of the method disclosed in implementations may be implemented through a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware of the processor.

The memory according to implementations of the present disclosure may be a volatile memory or a non-volatile memory, or may include both the volatile memory and the non-volatile memory. The non-volatile memory may be a ROM, a PROM, an erasable programmable read only memory (erasable PROM, EPROM), an electrically erasable programmable read only memory (electrically EPROM, EEPROM), or a flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link dynamic random access memory (synch-link DRAM, SLDRAM), and a direct rambus RAM (DRRAM).

The above description of the memory is intended for illustration rather than limitation. For example, the memory of implementations may also be an SRAM, a DRAM, an SDRAM, a DDR SDRAM, an ESDRAM, an SLDRAM, a DR RAM, etc. In other words, the memory of implementations is intended to include, but is not limited to, these and any other suitable types of memory.

Implementations of the present disclosure further provide a computer-readable storage medium. The computer-readable storage medium is configured to store computer programs.

Optionally, the computer-readable storage medium is applicable to the terminal device of implementations of the present disclosure. The computer programs are operable with a computer to implement the operations performed by the terminal device described in the foregoing method implementations, which will not be repeated herein for the sake of simplicity.

Optionally, the computer-readable storage medium is applicable to the network device of implementations of the present disclosure. The computer programs are operable with a computer to implement the operations performed by the network device described in the foregoing method implementations, which will not be repeated herein for the sake of simplicity. The network device may be a satellite or a ground station.

Implementations of the present disclosure further provide a computer program product. The computer program product includes computer program instructions.

Optionally, the computer program product is applicable to the terminal device of implementations of the present disclosure. The computer program instructions are operable with a computer to implement the operations performed by the terminal device described in the foregoing method implementations, which will not be repeated herein for the sake of simplicity.

Optionally, the computer program product is applicable to the network device of implementations of the present disclosure. The computer program instructions are operable with a computer to implement the operations performed by the network device described in the foregoing method implementations, which will not be repeated herein for the sake of simplicity. The network device may be a satellite or a ground station.

Implementations of the present disclosure further provide a computer program.

Optionally, the computer program is applicable to the terminal device of implementations of the present disclosure. The computer program, when executed by a computer, is operable with the computer to implement the operations performed by the terminal device described in the foregoing method implementations, which will not be repeated herein for the sake of simplicity.

Optionally, the computer program is applicable to the network device of implementations of the present disclosure. The computer program, when executed by a computer, is operable with the computer to implement the operations performed by the network device described in the foregoing method implementations, which will not be repeated herein for the sake of simplicity. The network device may be a satellite or a ground station.

In implementations of the present disclosure, the terms “system” and “network” are usually interchangeable. The term “and/or” herein describes only an association relationship for describing associated objects and represents that three relationships may exist. For example, A and/or B may represent the following three cases: only A exists, both A and B exist, and only B exists. In addition, the character “/” herein generally indicates an “or” relationship between the associated objects.

In implementations of the present disclosure, “B corresponding to A” represents that B is associated with A and B may be determined according to A. However, it should be further understood that B is determined according to A, which does not mean B is determined only according to A and B may further be determined according to A and/or other information.

Those of ordinary skill in the art will appreciate that units and algorithmic operations of various examples described in connection with implementations herein can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method implementations, which will not be repeated herein.

It will be appreciated that the systems, apparatuses, and methods disclosed in implementations herein may also be implemented in various other manners. For example, the above apparatus implementations are merely illustrative, e.g., the division of units is only a division of logical functions, and other manners of division may also available in practice, e.g., multiple units or assemblies may be combined or may be integrated into another system, or some features may be ignored or omitted. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

Various functional units described in implementations herein may be integrated into one processing unit or may be present as a number of physically separated units, and two or more units may be integrated into one.

If the integrated units are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computing device, e.g., a personal computer, a server, a network device, etc., to execute some or all operations of the methods described in various implementations. The above storage medium may include various kinds of media that can store program codes, such as a universal serial bus (USB) flash disk, a mobile hard drive, a ROM, a RAM, a magnetic disk, or an optical disk.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for cell handover, comprising:
acquiring a measurement report of cell measurement; and
adjusting the measurement report according to information representing a change in a communication distance between a terminal device and a network device, for cell handover.

2. The method of claim 1, wherein adjusting the measurement report according to the information representing the change in the communication distance between the terminal device and the network device comprises:
adjusting the measurement report according to an amount of change in the communication distance.

3. The method of claim 2, wherein the amount of change in the communication distance is:
a difference between the communication distance at a first moment and the communication distance at a second moment, wherein at the first moment, the measurement report is generated at the terminal device, and at the second moment, the measurement report is received at the network device.

4. The method of claim 2, further comprising:
determining the amount of change in the communication distance according to at least one of: round-trip time (RTT) between the terminal device and the network device, a moving distance of a satellite, and a moving distance of the terminal device.

5. The method of claim 1, wherein adjusting the measurement report according to the information representing the change in the communication distance between the terminal device and the network device comprises:
adjusting the measurement report according to a time difference between a first moment and a second moment, wherein at the first moment, the measurement report is generated at the terminal device, and at the second moment, the measurement report is received at the network device.

6. The method of claim 1, wherein adjusting the measurement report according to the information representing the change in the communication distance between the terminal device and the network device comprises:
determining an adjustment parameter according to the information representing the change in the communication distance; and
adjusting the measurement report with the adjustment parameter.

7. The method of claim 6, wherein the adjustment parameter comprises at least one of: an adjustment factor, an adjustment step size, and an adjustment period.

8. A communication device, comprising:
a memory configured to store computer programs; and
a processor configured to invoke and execute the computer programs stored in the memory to:
acquire a measurement report of cell measurement; and
adjust the measurement report according to information representing a change in a communication distance between a terminal device and a network device, for cell handover.

9. The communication device of claim 8, wherein the processor is configured to invoke and execute the computer programs stored in the memory to:
adjust the measurement report according to a time difference between a first moment and a second moment, wherein at the first moment, the measurement report is generated at the terminal device, and at the second moment, the measurement report is received at the network device.

10. The communication device of claim 8, wherein the processor is configured to invoke and execute the computer programs stored in the memory to:
determine an adjustment parameter according to the information representing the change in the communication distance; and
adjust the measurement report with the adjustment parameter.

11. The communication device of claim 10, wherein the adjustment parameter comprises at least one of: an adjustment factor, an adjustment step size, and an adjustment period.

12. The communication device of claim 8, further comprising a transceiver, wherein
the communication device is the terminal device, and the processor is configured to invoke and execute the computer programs stored in the memory to:
acquire the measurement report by performing cell measurement; and
cause the transceiver to:
transmit the adjusted measurement report to the network device; or
the communication device is the network device, and the processor is configured to invoke and execute the computer programs stored in the memory to:
control the transceiver to receive the measurement report transmitted by the terminal device.

13. The communication device of claim 8, wherein
the network device is a satellite, and the communication distance is a distance between the terminal device and the satellite; or
the network device is a ground station, and the communication distance is a sum of a distance between the terminal device and a satellite and a distance between the satellite and the ground station.

14. A satellite, wherein the satellite is a first satellite, and the first satellite comprises:
a processor;
a transceiver; and
a memory configured to store computer programs; wherein
the processor is configured to invoke and execute the computer programs stored in the memory to:
cause the transceiver to receive a measurement report of cell measurement transmitted by a terminal device;
determine a second satellite according to a satellite ephemeris; and
further cause the transceiver to transmit the measurement report to the second satellite for cell handover.

15. The satellite of claim 14, wherein
the measurement report comprises a measurement result of cell measurement and at least one of: a moving trajectory of the terminal device, a moving speed of the terminal device, and a valid duration of the measurement report; and
the processor is configured to invoke and execute the computer programs stored in the memory to:
determine the second satellite according to the satellite ephemeris and the measurement report.

16. The satellite of claim 14, wherein a distance between the first satellite and the terminal device is greater than a distance between the second satellite and the terminal device at a second moment when the measurement report is received at the first satellite.

17. The satellite of claim 14, wherein the processor is further configured to invoke and execute the computer programs stored in the memory to:
adjust the measurement report according to information representing a change in a communication distance between the terminal device and a satellite; wherein
the processor configured to invoke and execute the computer programs stored in the memory to cause the transceiver to transmit the measurement report to the second satellite is configured to invoke and execute the computer programs stored in the memory to cause the transceiver to:
transmit the adjusted measurement report to the second satellite.

18. The satellite of claim 17, wherein the processor is configured to invoke and execute the computer programs stored in the memory to:
adjust the measurement report according to an amount of change in the communication distance.

19. The satellite of claim 18, wherein the amount of change in the communication distance is:
a difference between the communication distance between the terminal device and the first satellite at a first moment and the communication distance between the terminal device and the second satellite at a second moment, wherein at the first moment, the measurement report is generated at the terminal device, and at the second moment, the measurement report is received at the first satellite.

20. The satellite of claim 18, wherein the processor is further configured to invoke and execute the computer programs stored in the memory to:
determine the amount of change in the communication distance according to at least one of: round-trip time (RTT) between the terminal device and the first satellite, a moving distance of the first satellite, and a moving distance of the second satellite, and a moving distance of the terminal device.
